(19) United States
(12) Patent Application Publication
(10) Pub. No.: US 2008/0163991 A1
(43) Pub. Date: Jul. 10, 2008

(54) Portable Screen System

(75) Inventors: Tyler Ernst Dettbarn, Calgary (CA); Kurt Joachim Dettbarn, Toronto (CA)

Correspondence Address: FRANKLIN & ASSOCIATES INTERNATIONAL LLC, 230 St. Francis Drive, Suite 1, SANTA FE, NM, 87505-3538, US

(73) Assignee: BACKYARD DRIVE-IN INCORPORATED, Calgary (CA)

(21) Appl. No.: 11/619,976

(22) Filed: Jan. 4, 2007

(51) Int. Cl. G03B 21/56

(52) U.S. Cl. 160/377

(57) ABSTRACT

The present invention relates generally to a portable screen system (PSS) for use with projecting equipment or for advertising. The PSS includes a collapsible frame that may be opened to an expanded position to support a screen. The PSS includes locking straps and support lines allowing the PSS to be erected in a variety of locations including both indoor and outdoor locations.

### FIELD OF THE INVENTION

The present invention relates generally to a portable screen system (PSS) for use with projecting equipment or for advertising. The PSS includes a collapsible frame that may be opened to an expanded position to support a screen. The PSS includes locking straps and support lines allowing the PSS to be erected in a variety of locations including both indoor and outdoor locations.

### BACKGROUND OF THE INVENTION

With the growing use, availability and decreasing cost of portable LCD projectors, laptop computers and DVD players, the ability to create and present professional quality multi-media shows or play movies has been steadily increasing. Moreover, and more specifically LCD projectors are powerful devices capable of projecting high resolution images considerable distances and onto large screens. For example, it is well known that many multi-media presentations are made where LCD projectors are connected to a laptop and projected onto conventional screens for promotional or entertainment purposes. In addition, there is considerable use of LCD projectors in home theatre systems.

As the use of such projectors continues to increase, people are continuing to envisage and wanting to utilize their projection systems in an increasing number of places. However, in many situations, it is impractical, difficult or overly expensive to utilize conventional screens in such locations.

As a result, there has been a need for a portable screen system that solves the problems as outlined above and in particular, there has been a need for an inexpensive portable screen system that can be readily transported to many locations including outdoor locations and where erection of the portable screen system is quick and simple.

In addition, there has been a need for a portable screen system that can accommodate multiple screen sizes on a single frame thereby increasing the flexibility of use of the screen system in different locations.

Still further, there has been a need for a portable screen system that can also be used to support other material such as advertising material.

### SUMMARY OF THE INVENTION

The invention relates generally to a portable screen system (PSS) for use with projecting equipment or for advertising. The PSS includes a collapsible frame that may be opened to an expanded position to support a screen. The PSS includes locking straps and support lines allowing the PSS to be erected in a variety of locations including both indoor and outdoor locations.

More specifically, in accordance with the invention, there is provided a portable screen system (PSS) comprising: a collapsible frame including a plurality of front knuckles and rear knuckles each front and rear knuckle operatively connected to at least two support rods, the collapsible frame operatively moveable between a collapsed and an expanded position and wherein a plurality of front knuckles include a screen mounting system; a knuckle locking system for operatively connecting at least one front and rear knuckle pairs together in the expanded position; a screen for mounting on the screen mounting system when the collapsible frame is in the expanded position.

### BRIEF DESCRIPTION OF THE DRAWINGS

Embodiments of the present invention will now be described, by way of example, with reference to the attached Figures, wherein:

FIG. 1 is a perspective front view of an assembled screen system in accordance with one embodiment of the invention;

FIG. 2 is a perspective rear view of an assembled screen system in accordance with one embodiment of the invention;

FIG. 3 is a front view of an assembled screen system in accordance with one embodiment of the invention;

FIG. 4 is a rear view of an assembled screen system in accordance with one embodiment of the invention;

FIG. 5 is a side view of an assembled screen system in accordance with one embodiment of the invention;

FIG. 6 is a perspective view of an assembled screen system showing details of a knuckle and strap in accordance with one embodiment of the invention;

FIG. 7 is a perspective and exploded view of a knuckle and strap in accordance with one embodiment of the invention;

FIG. 8 is a rear perspective view of a knuckle in accordance with one embodiment of the invention;

FIG. 9 is an exploded, forward perspective view of a knuckle, mushroom knob and strap connector in accordance with one embodiment of the invention;

FIG. 10 is a rear perspective view of a strap connection in accordance with one embodiment of the invention;

FIG. 11 is a forward perspective view of a mushroom knob in accordance with one embodiment of the invention;

FIG. 12 is a forward perspective view of a strap connector and buckle in accordance with one embodiment of the invention;

FIG. 13 is a perspective view of a mating strap connector and buckle in accordance with one embodiment of the invention;

FIG. 14 is a perspective view of a foot brace system in accordance with one embodiment of the invention;

FIG. 15 is an exploded perspective view of a foot brace system in accordance with one embodiment of the invention;

FIG. 16 is a perspective front of a collapsed support frame in accordance with one embodiment of the invention; and,

FIG. 17 is a perspective view of a peg anchor in accordance with one embodiment of the invention.

### DETAILED DESCRIPTION

With reference to the Figures, a portable screen system (PSS) 10 is described for use as an effective support for a projection screen and/or for supporting other materials such as advertising material. The PSS 10 is designed to enable rapid erection and collapse of the system thereby permitting the temporary or semi-permanent use of the PSS in a variety of locations.

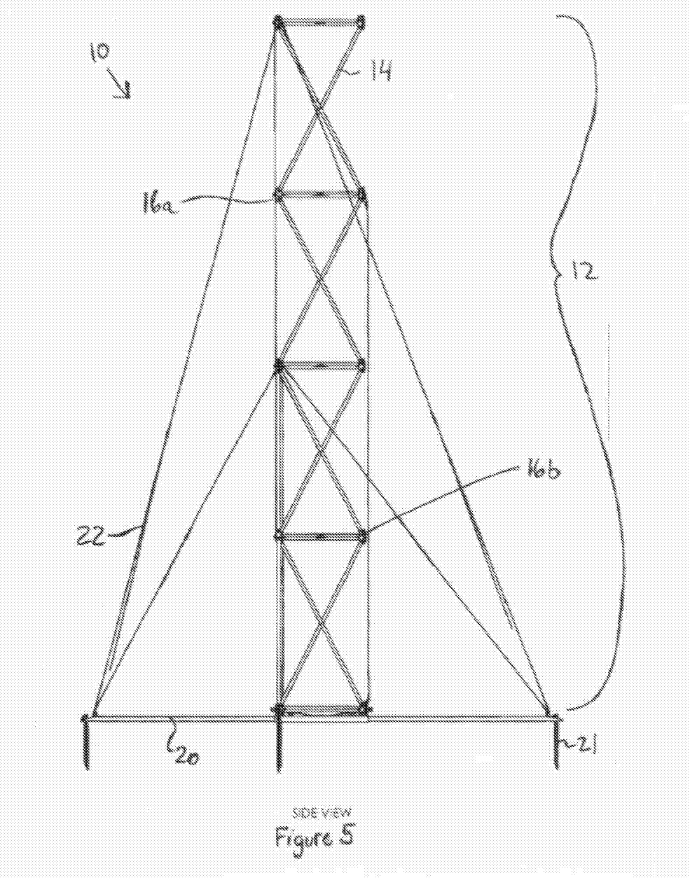

With reference to FIGS. 1-5 and 5A, the PSS 10 generally includes a frame 12 comprised of a plurality of support rods 14, knuckles 16, locking straps 18, foot braces 20, stakes 21, support lines 22 and screen 24. For clarity, all reference numerals may not be shown in each Figure.

As shown in FIGS. 1-5 and 5A, the frame 12 includes support rods 14 hingedly interconnected by forward and rear knuckles 16a, 16b. In the collapsed form (FIG. 5A), the frame generally defines a three-dimensional rectangular form that may be readily inserted within an appropriate carrying case (not shown). In the collapsed position, the forward 16a and rear 16b knuckles are each adjacent three or more corresponding knuckles (defining a forward and rear plane) with the support rods 14 generally aligned parallel to one another and separating the forward and rear knuckles.

During assembly, the PSS is expanded from the collapsed to the expanded positions. In the expanded position, as shown in FIGS. 1-5, the forward and rear knuckles are generally spread away from adjacent forward or rear knuckles such that the corresponding forward and rear planes are brought closer together and corresponding forward and rear knuckle pairs are also brought closer together. Straps 18 are used to interconnect a number of corresponding forward and rear knuckle pairs to lock the PSS in the expanded position. A screen 24 is placed over and secured to the forward knuckles whilst the frame is preferably in a horizontal position and support lines 22 are attached to the upper corners of the frame. Foot braces 20 are attached to the lower corners of the frame and after rotation of the frame and screen to a vertical position, the support lines are attached to the outer regions of the foot braces. Stakes 21 may be optionally used to secure the PSS to the ground if the screen has been erected outside on soft ground.

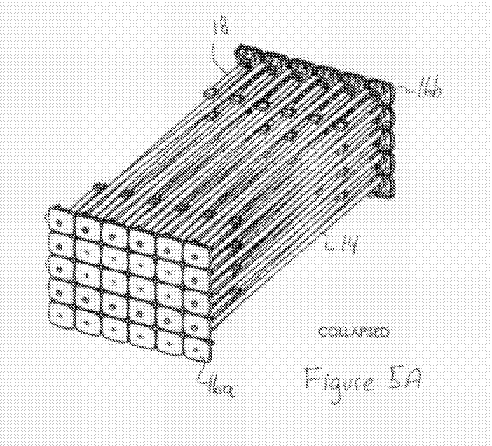

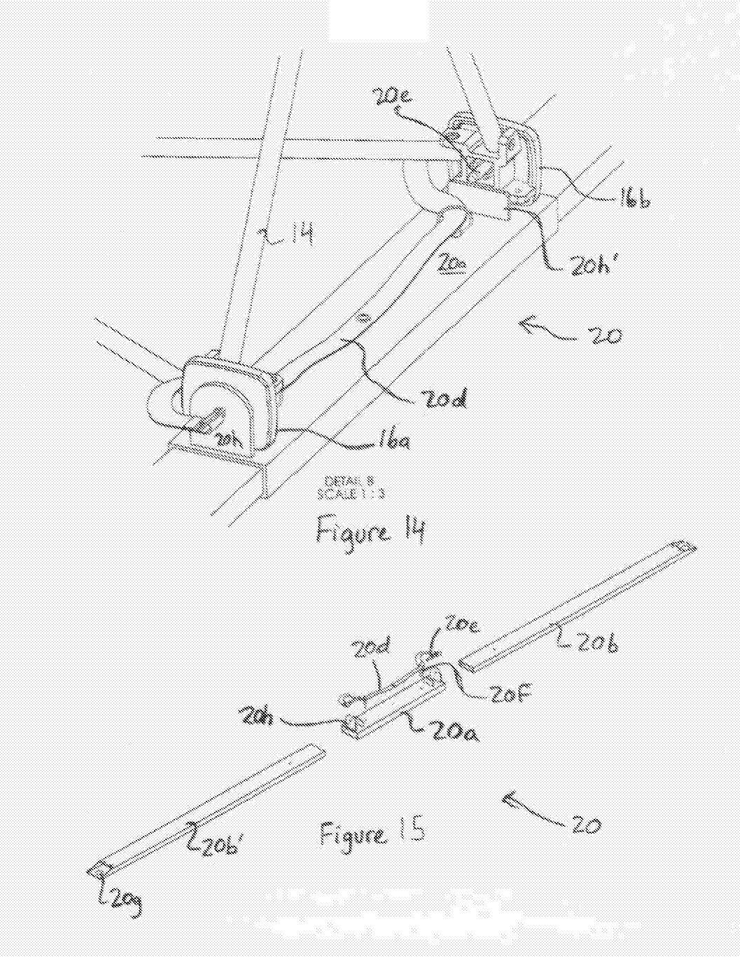

FIG. 6-13 show further details of the construction, assembly and operation of the knuckles 16, locking straps 18 and support lines 22 of the PSS 10.

### Knuckles

In a preferred embodiment, forward and rear knuckles 16a, 16b are identical in design with each having inward 16c and outward 16d surfaces. The outward surfaces 16d are generally smooth, convex surfaces and the inward surfaces 16c are generally designed both to connect to the support rods 14 and strap system 18 of the PSS.

The outward surface 16d is designed to allow use of the knuckle in various locations of the frame where the knuckle has the functionality of a) attaching and tensioning the perimeter of the screen, b) tensioning the inner regions of the screen and, otherwise, c) providing basic frame support. That is, the basic structure of the knuckle 16 enables the use of the knuckle at locations including the perimeter of the screen as well as all remaining locations of the frame on the forward or rear sides of the frame.

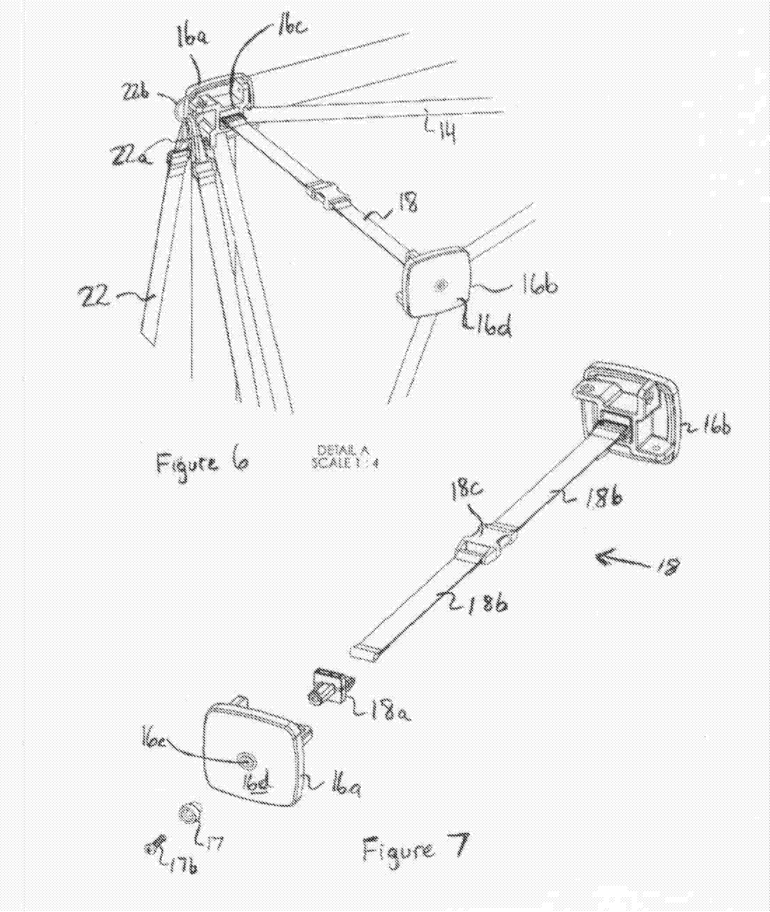

With reference to FIG. 7, a forward and rear knuckle pair 16a, 16b is shown in an exploded view showing details of the configuration of a knuckle in both the forward and rear locations together with a strap system 18 for interconnecting the forward and rear knuckle pair.

The forward knuckle 16a, when located on the perimeter of the frame is configured with a mushroom knob 17 for insertion within a grommet hole of the screen 24 (as will be described below). The mushroom knob 17 is configured to the knuckle 16a by inserting the stem 17a of the mushroom knob within a hole 16e on the outward surface 16d of the knuckle 16a. A screw 17b is inserted through the mushroom head 17 for attachment to a strap connector 18a seated within the inward surface 16c of the knuckle.

The knuckle, when located on an interior position of the forward side of the frame or the rear side of the frame is not configured with the mushroom head. Thus, the screw 17b is inserted through the hole 16e on the outward surface of the knuckle 16 for attachment to the strap connector 18a as described above.

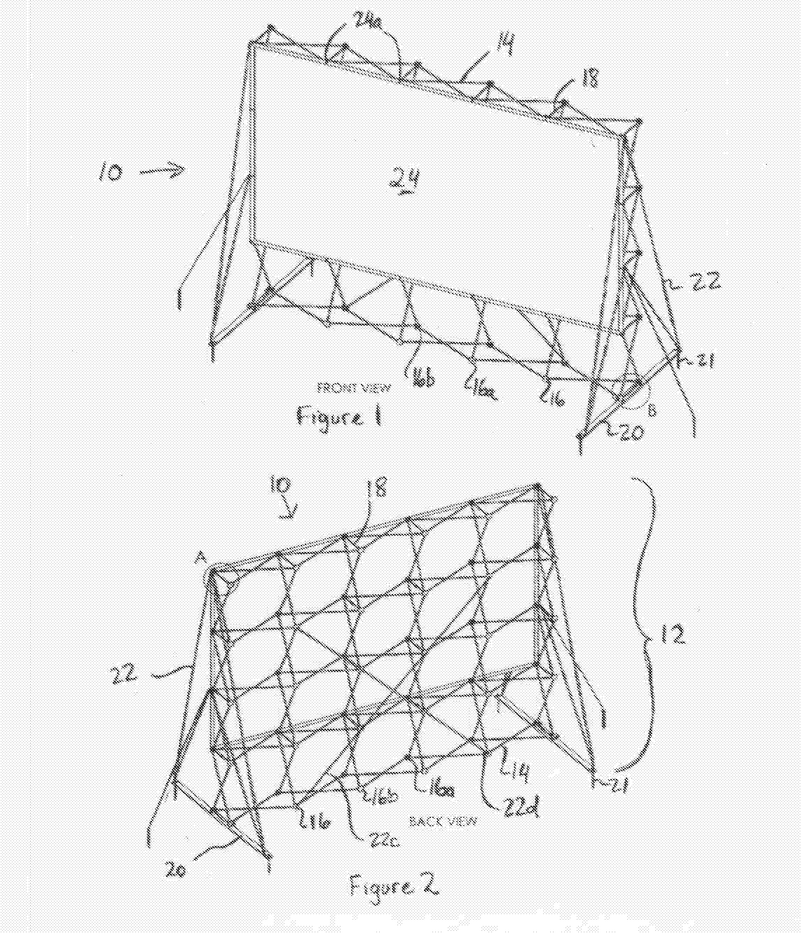

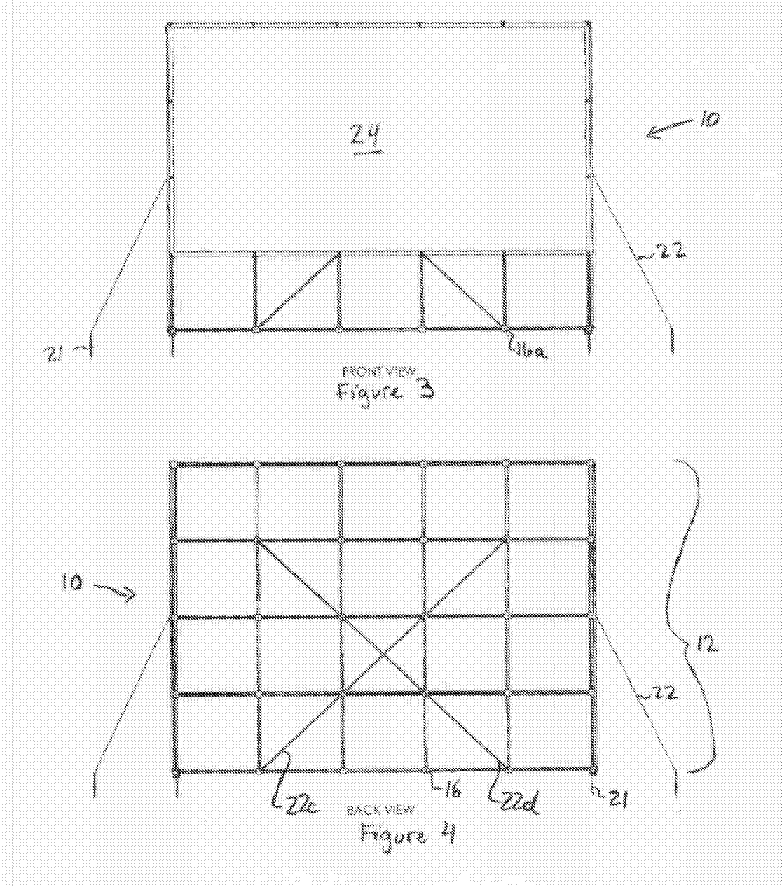

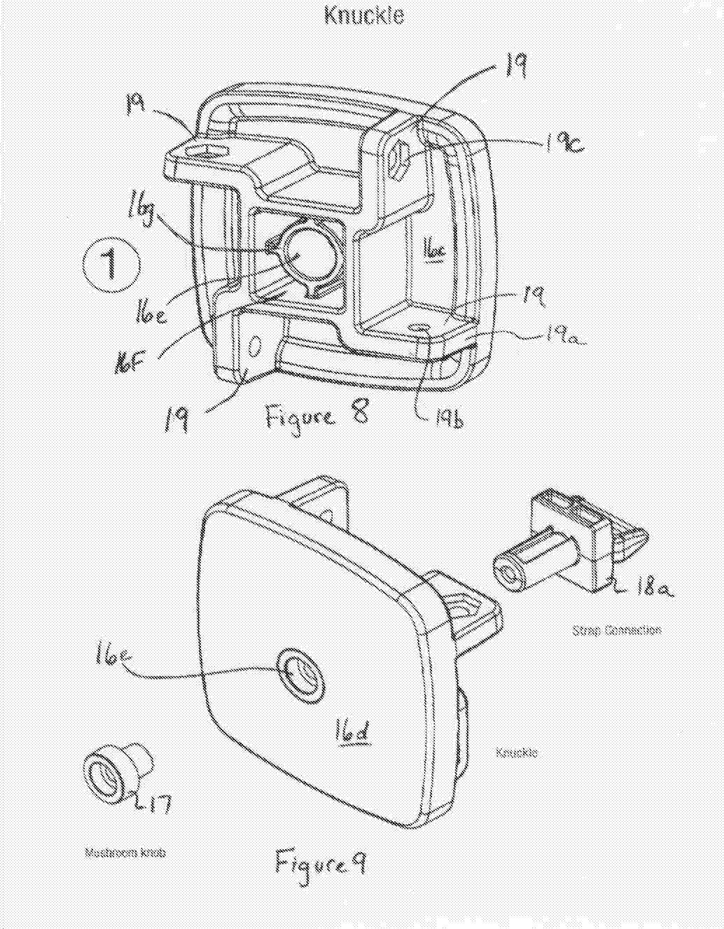

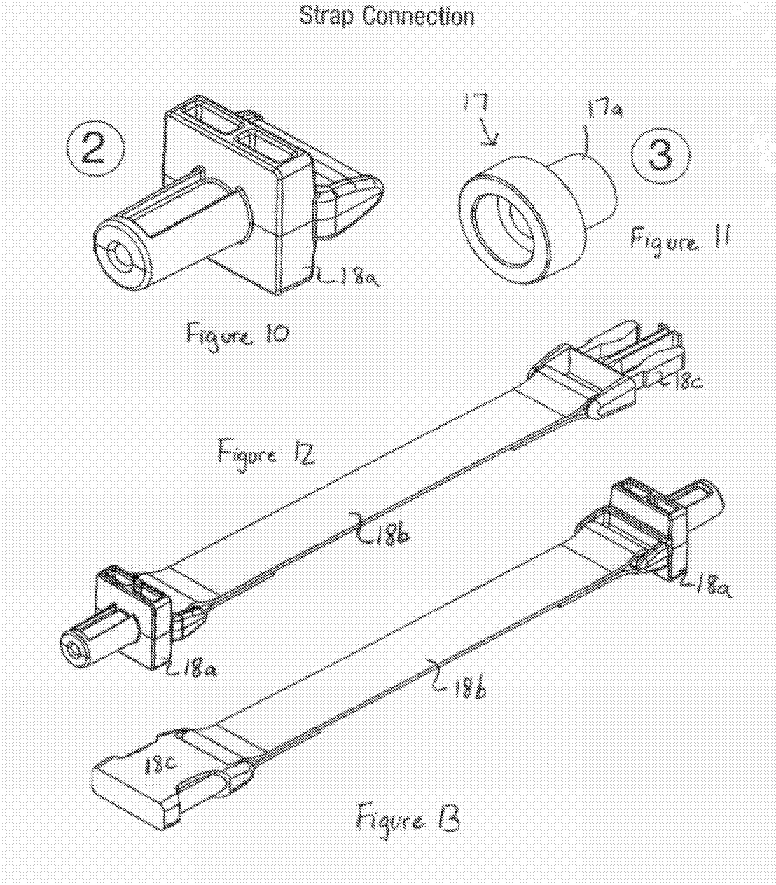

As shown most clearly in FIG. 8, the inward side 16c of the knuckle is provided with four attachment points 19 for attaching up to four support rods. That is, and as shown in FIG. 2, in a corner position, two support rods are attached to the knuckle, in an edge position, three support rods are attached to the knuckle and in an interior position, four support rods are attached to the knuckle. Each of the four attachment points 19 includes an outwardly projecting flange 19a having a hole 19b allowing the insertion of a fastener such as a nut and bolt. As shown, the hole 19b includes a recessed surface 19c corresponding to the head of a hexagonal bolt or nut to assist in the initial assembly of the frame so as to alleviate the need for two tightening devices when attaching the support rods 14 to the knuckles 16.

The inward side 16c of the knuckle further includes a central recess 16f for seating the strap connector 18a within the knuckle 16. In a preferred embodiment, the recess 16f includes appropriate ridges or members 16g to structurally enhance the rigidity of the knuckle 16.

The knuckle 16 may be manufactured from any suitable material including plastics or metal.

### Support Rods 14

The support rods 14 may be any suitable rod manufactured from appropriate metals, plastics or composites that provide sufficient strength and rigidity to the frame 12. Ideally, support rods 14 are both light weight and rigid to reduce the overall weight of the PSS 10 for ease of transport whilst providing sufficient rigidity to the frame 12 such that the frame 12 does not flex in normal use and particularly if being used in gentle winds. Support rods 14 manufactured from aluminium having a square cross-section have been found to provide an appropriate balance between acceptable cost, weight and rigidity. It is understood that other materials and other cross-sectional profiles of support rods may be used. Support rods 14 may be provided with appropriate end-caps (not shown) to facilitate connection of the support rods 14 to the knuckles 16.

### Strap and Strap Connector

The strap connector 18a is designed to attach to the knuckle 16 within the knuckle recess 16f. The strap connector 18a includes an appropriate attachment system to attach a strap to the strap connector.

The strap 18b preferably includes two sections, each attached to a strap connector 18a on a knuckle pair 16a, 16b and having a quick connector 18c allowing rapid connection and disconnection of the straps 18b. The strap 18b may be adjustable or of a fixed length as shown in the Figures.

### Foot Support

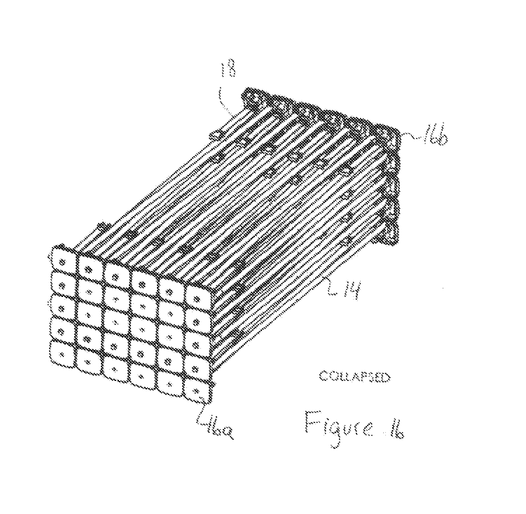

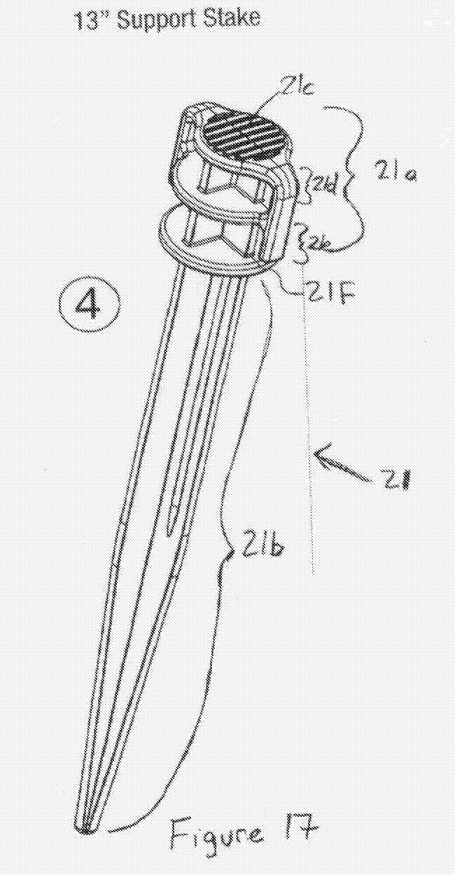

With reference to FIGS. 14 and 15, the foot support 20 is described. As shown, the foot support 20 preferably includes three sections, including a center support 20a and two outer sections 20b, 20b′ for engagement within the center support 20a. The centre section 20a includes two brackets 20h, 20h′ for receiving the lower corner knuckles 16a, 16b of the frame 12 and a locking system 20d for securing the corner knuckles to the brackets 20h, 20h′ and the outer sections 20b, 20b′ to the center support 20a.

The locking system 20d, in one embodiment, is a strap that is optionally secured to the center support, the locking system having two end pins 20e and two center pins 20f. The center pins 20f are inserted within corresponding holes within the center support 20a and outer sections 20b, 20b′ to secure the outer sections to the center support. The end pins 20e are inserted through bracket holes and the center hole 16e of each corner knuckle.

In various embodiments, the foot support 20 may be telescopic elements and/or the brackets of the center support may be positioned at varying locations on the foot support.

### Support Lines

The support lines 22 may be straps or other lines known to those skilled in the art. In a preferred embodiment, as shown in FIG. 6, the support lines are provided with hooks 22a for engagement with a top corner knuckle. As shown, the hooks 22a may be used to engage with a top corner knuckle through a ring 22b configured to an unused hole on the knuckle 16. The lower end of the straps may be attached to appropriate anchor points 20g on the foot supports 20 or by a stake 21 described below. The support lines 22 may also be adjustable.

In order to improve the stability of the frame other support straps may also be utilized. As shown in FIG. 2, cross bracing straps 22c and 22d may be attached and tightened to selected knuckles to increase the rigidity of the frame.

### Screen

The screen 24 may be manufactured from various materials but is preferably manufactured from materials providing both sufficient density to allow high resolution images to be projected on the screen whilst also providing a degree of porosity to reduce wind resistance of the PSS if used outdoors. In addition, the screen 24 should have sufficient strength and elasticity to provide a flat surface for projection when properly tensioned on the front side of the frame 12. As such, it has been determined that nylon-coated polyester having an open weave of 1-10% void space provides an appropriate screen surface. A void space of 3% is optimal.

The screen 24 also includes a series of grommets 24a on the perimeter of the screen at locations enabling placement of the grommets 24a over corresponding mushroom knobs 17 on the knuckles.

Appropriate sizing and tensioning of the screen 24 provides counter-tension to the frame straps that together assists in preventing dimpling in the screen 24.

### Stake

With reference to FIG. 17, a ground stake 21 for securing support lines 22 to the ground for outdoor applications is described. In a preferred embodiment, the stake 21 enables the use of different strap connection systems with a single design of stake 21. In the embodiment shown in FIG. 17, the stake includes head 21a and lower ground penetrating 21b sections. The head section 21a includes a flat upper surface 21c enabling the use of a mallet or other hammer device to drive the stake into the ground. The flat surface also minimizes the risk of injury to persons who may accidentally step on the exposed head section when the stake has been driven into the ground. The flat surface may also be textured to reduce mallet slippage.

Preferably, the head section 21a includes both a closed ring section 21d and an open-ring section 21d allowing support straps having any number of connectors to be effectively connected to the stake. For example the closed ring section 21e may be used with hook-type connectors that are clipped through the closed ring. Alternatively, the open-ring section 21e may be used to allow free rope support lines to be tied to the connector thereby giving the user additional flexibility in securing and stabilizing the PSS 10 to the ground.

A depth ring 21f may also be included to assist the user in determined the preferred depth of ground penetration.

The lower ground penetrating section 21b is preferably tapered having a cruciform cross-section to promote the ability of the stake to penetrate the ground while also improving the strength of the stake.

In one embodiment, the stake is manufactured from a brightly-coloured or fluorescent plastic in order to make the stake more visible.

### Applications

The PSS may be manufactured to any desired dimension depending on the desired use and location of use. Typical dimensions for outdoor use may include 16 by 12 foot screen sizes although both larger and smaller screens may be utilized for indoor or outdoor use in both commercial and residential buildings and settings.

The PSS may be used as a screen for use with any form of projection device including LCD projectors and/or traditional projection devices.

The PSS may also be used as a system to support advertising or printed material on the screen.

In yet a further embodiment, a single frame may be utilized with different size screens. For example, it may be desired that a full 16 by 12 foot screen size is desired for certain locations but a smaller screen is required for other locations. That is, in expanding the frame from the collapsed to the expanded positions, the ultimate size of the frame can be determined by fixing degree of expansion at any position intermediate between the fully collapsed and fully expanded positions. As a result, if it is desired to utilize a smaller screen, the frame may be expanded and secured through longer locking straps at any intermediate position. A smaller screen may then be attached to the front side as described above. Proper tensioning of the screen may be accomplished by adjustable locking straps or by fixed length extension straps (not shown) that may be attached to the quick release system. It is understood that in creating an intermediate size screen, the front-to-back width of the frame will be greater and therefore may require corresponding foot supports of a greater width.

### Assembly

In a 16 by 12 foot embodiment, the PSS generally requires two persons to assemble and erect the PSS. The frame, with interconnected knuckles, support rods and straps is expanded from the collapsed form with the front side of the frame facing up. Straps on the inner portions of the frame are connected to provide initial rigidity to the system. The grommets of the screen are then placed over the mushroom knobs and the remaining perimeter support straps connected to fully tension the frame and screen. The center sections of the support leg are then connected to the lower corner knuckles of the frame and one of the two outer sections of the support leg attached and locked to the center section. Support straps are connected to the upper corner knuckles and other locations of the frame as may be desired. The frame is then tilted to the vertical position and preferably oriented such that the plane of the screen is generally parallel to the wind direction, if any. The remaining outer section of the support leg is attached if required and stakes and support straps placed and attached to properly stabilize the system.

The above-described embodiments of the present invention are intended to be examples only. Alterations, modifications and variations may be effected to the particular embodiments described herein by those of skill in the art without departing from the scope of the invention.

1. A portable screen system (PSS) comprising:
a collapsible frame including a plurality of front knuckles and rear knuckles each front and rear knuckle operatively connected to at least two support rods,
the collapsible frame operatively moveable between a collapsed and an expanded position and wherein a plurality of front knuckles include a screen mounting system;
a knuckle locking system for operatively connecting at least one front and rear knuckle pairs together in the expanded position;
a screen for mounting on the screen mounting system when the collapsible frame is in the expanded position.

2. A portable screen system as in claim 1 wherein the front knuckles and rear knuckles include a convex outer surface and an inner surface for attachment of at least two support rods.

3. A portable screen system as in claim 2 wherein the screen mounting system includes a mushroom knob on the convex outer surface of a knuckle.

4. A portable screen system as in claim 1 further comprising a foot support system for attachment to at least one lower corner of the frame to stabilize the frame in the vertical position.

5. A portable screen system as in claim 4 further comprising a plurality of support lines to support the PSS in a vertical position.

6. A portable screen system as in claim 2 wherein the knuckle locking system includes a strap system attached to the inner surface of a pair of front and rear knuckles for operatively locking the frame in an expanded position.

7. A portable screen system as described in claim 1 further comprising a stake having an open ring connector and closed ring connector.

8. A portable screen system as in claim 7 wherein the stake is a bright fluorescent colour.

9. A portable screen system as in claim 1 wherein the knuckle locking system allows locking the frame at any intermediate position between the collapsed and intermediate positions.

10. A portable screen system as in claim 1 wherein the screen is a nylon-coated polyester having an open weave with a 1-10% void space.

11. A portable screen system as in claim 10 wherein the void space is 3%.

12. A portable screen system as in claim 4 wherein the foot support system includes brackets for receiving corner knuckles and pins for locking the corner knuckles to the foot support system.

13. A portable screen system as in claim 9 further comprising a second screen sized to fit the frame at an intermediate position.
